(19) United States
(12) Patent Application Publication
(10) Pub. No.: US 2026/0147378 A1
(43) Pub. Date: May 28, 2026

(54) ELECTRONIC DEVICE

(71) Applicant: Lenovo (Beijing) Limited, Beijing (CN)

(72) Inventors: Yangjian HU, Beijing (CN); Min ZHUO, Beijing (CN)

(21) Appl. No.: 19/384,558

(22) Filed: Nov. 10, 2025

(30) Foreign Application Priority Data
Nov. 26, 2024 (CN) 202411699182.6

(51) Int. Cl. G06F 1/16

(52) U.S. Cl. CPC G06F 1/1616

(57) ABSTRACT

An electronic device includes a first body including a display assembly, a second body rotatably connected to the first body, and a target assembly configured to limit a rotation angle range of the first body relative to the second body. The first body is configured to switch between first and second display states, in which the display assembly has different display area. When the display assembly switches to the first display state, the target assembly switches to a first target state in which the rotation angle range of the first body relative to the second body is a first angular range. When the display assembly switches to the second display state, the target assembly switches to a second target state in which the rotation angle range of the first body relative to the second body is a second angular range different from the first angular range.

### CROSS-REFERENCE TO RELATED APPLICATION

This application claims priority to Chinese Patent Application No. 202411699182.6, filed on November 26, 2024, the entire content of which is incorporated herein by reference.

### TECHNICAL FIELD

The present disclosure generally relates to the field of electronic technologies, and, more particularly, to an electronic device.

### BACKGROUND

Currently, an electronic device has a flexible display, which can be rolled in and out through a motion structure to make the display area smaller or larger, making it easier for people to use.

### SUMMARY

In accordance with the disclosure, there is provided an electronic device including a first body including a display assembly, a second body rotatably connected to the first body, and a target assembly configured to limit a rotation angle range of the first body relative to the second body. The first body is configured to switch between a first display state and a second display state, and a display area of the display assembly in the first display state is different from the display area of the display assembly in the second display state. The target assembly is configured to, in response to the display assembly switching to the first display state, switch to a first target state in which the rotation angle range of the first body relative to the second body is a first angular range, and in response to the display assembly switching to the second display state, switch to a second target state in which the rotation angle range of the first body relative to the second body is a second angular range different from the first angular range.

### BRIEF DESCRIPTION OF THE DRAWINGS

To more clearly illustrate the technical solutions of the embodiments of the present disclosure, the drawings needed for use in the description of the embodiments will be briefly introduced below. The drawings described below are some embodiments of the present disclosure. For those of ordinary skill in the art, other drawings can be obtained according to these drawings without any creative work. Throughout the drawings, the same or similar reference numerals represent the same or similar elements. It should be understood that the drawings are schematic and that the originals and elements are not necessarily drawn to scale.

FIG. 1 is a schematic structural diagram of an electronic device in a first display state consistent with embodiments of the present disclosure.

FIG. 2 is an enlarged view of part a in FIG. 1 consistent with embodiments of the present disclosure.

FIG. 3 is a schematic structural diagram of a target assembly of an electronic device in a second display state consistent with embodiments of the present disclosure.

FIG. 4 is another schematic structural diagram of a target assembly of an electronic device in a second display state consistent with embodiments of the present disclosure.

FIG. 5 is another schematic structural diagram of an electronic device in a first display state consistent with embodiments of the present disclosure.

FIG. 6 is another schematic structural diagram of an electronic device in a second display state consistent with embodiments of the present disclosure.

FIG. 7 is structural diagram showing comparison between a first display state and a second display state of an electronic device consistent with embodiments of the present disclosure.

FIG. 8 is another schematic structural diagram of an electronic device in a second display state consistent with embodiments of the present disclosure.

FIG. 9 is a schematic structural diagram of a target assembly in an electronic device in a second display state consistent with embodiments of the present disclosure.

FIG. 10 is another schematic structural diagram of a target assembly in an electronic device in a second display state consistent with embodiments of the present disclosure.

### Numerical referrals:

1 - First body; 2 - Second body; 30 - Brake member; 31 - First rotation member; 311 - Abutment member; 311a - Abutment wall; 32 - Second rotation member; 33 - Connection assembly; 34 - Drive member; 35 - First support member; 36 - Guide post; 37 - Slider; 38 - Screw rod; 39 - Second support member; 40 - Connection rod; 41 - First gear; 42 - Second gear; 44 - Drive gear; 45 - Gear assembly; 46 - Fourth gear; 461 - First toothed structure; 462 - First stop; 47 - Fifth gear; 471 - Second toothed structure; 472 - Second stop.

### DETAILED DESCRIPTION OF THE EMBODIMENTS

Various schemes and features of the present disclosure are described herein with reference to the accompanying drawings. The terms used in the present disclosure are only used to explain the specific embodiments of the present disclosure and are not intended to limit the scope of the present disclosure. It is understandable to those skilled in the art that with the development of technology and the emergence of new scenarios, the technical solutions provided in the embodiments of the present disclosure are also applicable to similar technical problems.

The terms “first/second/third” involved in the present disclosure are only used to distinguish similar objects, and do not represent a specific order for the objects. It is understood that objects described by “first/second/third” can be interchanged with a specific order or sequence where permitted, such that the embodiments of the present disclosure described here can be implemented in an order other than that illustrated or described here. The terms “including,” “comprising,” or “having,” and any variations thereof, are intended to cover a non-exclusive inclusion, such that a process, method, system, product, or apparatus that comprises a list of elements is not necessarily limited to those elements but may include other elements not expressly listed or inherent to such process, method, product, or device. Unless otherwise defined, all technical and scientific terms used in the present disclosure have the same meaning as those generally understood by those skilled in the art. The terms used in the present disclosure are only for the purpose of description and are not intended to limit the scope of the present disclosure.

An electronic device typically includes a first body, a second body, and a rotation shaft mechanism connecting the first body and the second body. The rotation shaft mechanism is connected to the first body and the second body, respectively, to enable the first body to open and close at an adjustable angle relative to the second body. The angle between the first body and the second body can be adjusted, allowing the electronic device to remain independent and stationary when in contact with a support object while also being convenient for the user.

In some examples, the second body contacts the support object, whereupon the second body can serve as a support for the first body. The first body can be a body that can receive operations from an operating object, such as a control panel or display interface. When using the electronic device, the user can place the electronic device on a desktop or other support object, with the second body facing the desktop or other support object. The electronic device also includes a flexible screen for display, which can be attached to the first body and/or the second body. The flexible screen is flexible and can achieve adaptive deformation in response to the sliding position while maintaining performance.

With the increasing multifunctionality of electronic devices, user demands have also increased. Existing electronic devices have relatively simple display modes that fail to meet user needs.

The present disclosure provides an electronic device to at least partially alleviate the above problems.

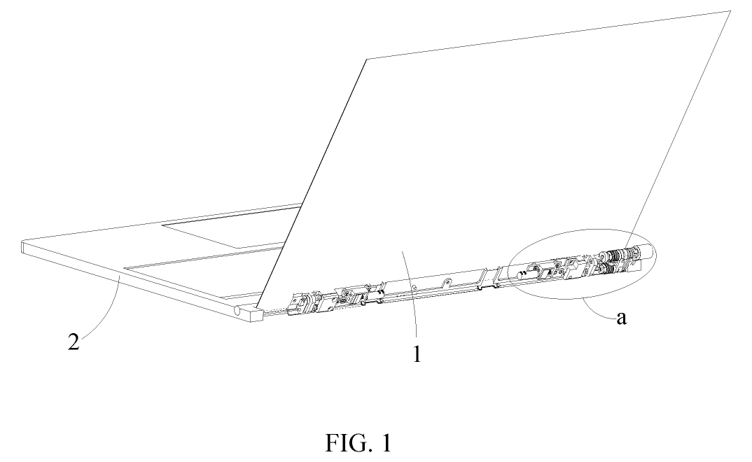

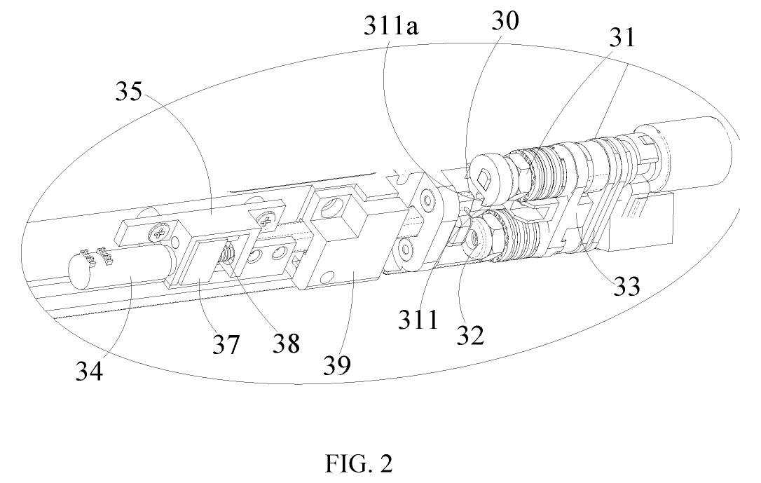

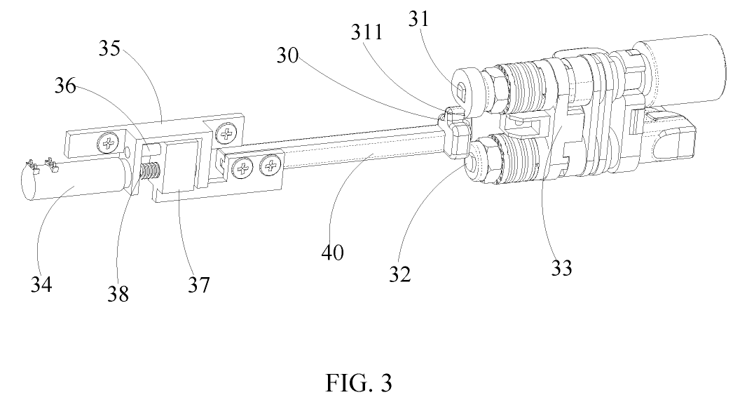

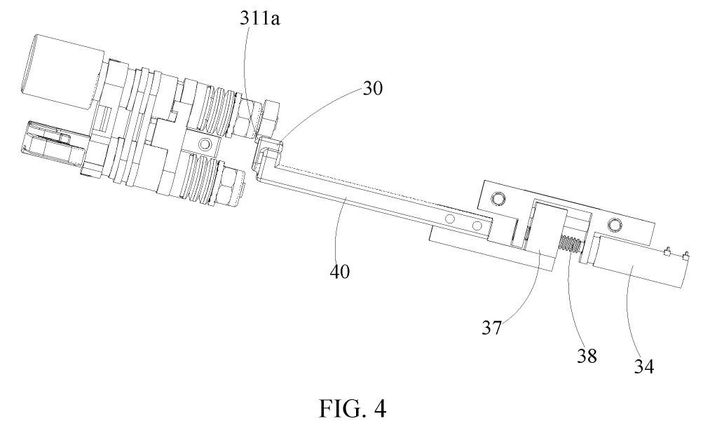

As shown in FIG. 1, FIG. 2, FIG. 3, and FIG. 4, in one embodiment, the electronic device may include a first body 1, a second body 2, and a target assembly. The first body 1 and the second body 2 may form two parts of the electronic device that are able to be opened or closed. The first body 1 and the second body 2 may each be connected to a rotation shaft mechanism. The rotation shaft mechanism may drive the first body 1 to rotate toward or away from the second body 2, thereby opening and closing the electronic device. Taking a laptop computer as an example, the first body may be a screen component, and the second body may be a host component.

The first body 1 may include a display assembly, which may be a display device used by the electronic device. For example, the display assembly may be a display screen.

The first body 1 may have a first display state and a second display state that are switchable. The first body 1 may have at least two display states, namely, a first display state and a second display state, between which the first body 1 is able to switch. Optionally, the first body 1 may also have a third display state, which may be a state between the first display state and the second display state. Optionally, the first body 1 may have different structural relationships in the first display state and the second display state. As the relationship between structural components of the first body 1 changes, the center of gravity of the first body 1 may also change. Optionally, the display area (i.e., the size of the region for display) of the first body 1 serving as the display surface may be different in the first display state and the second display state.

The display area of the display assembly in the first display state may be different from the display area of the display assembly in the second display state. The display assembly may have different display areas in the first display state and the second display state. For example, the display output area of the display screen may be different in the first display state and the second display state, allowing users to adjust the display state of the electronic device based on different usage needs, thereby improving the user experience of the electronic device.

The target assembly may be disposed at the rotation shaft mechanism or may be in a mating relationship with the rotation shaft mechanism.

Optionally, the target assembly may be in a first target state when having a first mating relationship with the rotation shaft mechanism and in a second target state when having a second mating relationship with the rotation shaft mechanism. Optional, the target assembly may be in a mating relationship with the first body 1. The target assembly may be in the first target state when having the first mating relationship with the first body 1 and in the second target state when having the second mating relationship with the first body 1.

The second body 2 may be rotatably connected to the first body 1. The target assembly may be used to limit the rotation angle range of the first body 1 relative to the second body 2. The target assembly may have a first target state and a second target state. The target assembly may change states. The main function of the target assembly may be to limit or control the rotation angle range of the first body 1 of the electronic device relative to the second body 2, which allows users to adjust the angle of the first body 1 of the electronic device based on different usage needs, allowing users to find the appropriate angle for the first body 1 of the electronic device in different display states and thereby improving the user experience of the electronic device.

In the first target state, the rotation angle range of the first body 1 relative to the second body 2 may be a first angle range, which may be any angle between 0° and the maximum rotation angle of the first body 1 relative to the second body 2 in the first target state. In the second target state, the rotation angle range of the first body 1 relative to the second body 2 may be a second angle range, which may be any angle between 0° and the maximum rotation angle of the first body 1 relative to the second body 2 in the second target state. The second angle range may be different from the first angle range. The target assembly may limit or control the upper limit of the rotation angle of the first body 1 relative to the second body 2, allowing the electronic device to be stably placed on a desktop or other support object in different postures. For example, in the first target state, the upper limit of the first angle range may be 135°, and in the second target state, the upper limit of the second angle range may be 120°. That is, in the first target state, the upper limit of the rotation angle of the first body 1 relative to the second body 2 may be 135°, and in the second target state, the upper limit of the rotation angle of the first body 1 relative to the second body 2 may be 120°.

When the first body 1 switches between the first display state and the second display state, the relationship between the structures of the first body 1 itself may change, and the display area of the first body may be different. The target assembly may be used to limit the rotation angle range of the first body 1 relative to the second body 2. When the display assembly switches to the first display state, the target assembly may switch to the first target state. In the first target state, the rotation angle range of the first body 1 relative to the second body 2 may be the first angle range. When the display assembly switches to the second display state, the target assembly may switch to the second target state. In the second target state, the rotation angle range of the first body 1 relative to the second body 2 may be the second angle range. This may allow the electronic device to have different rotation angle ranges of the first body 1 relative to the second body 2 when the display area is different. In this embodiment, the target assembly may be used to limit the rotation angle range of the first body 1 relative to the second body 2, allowing the user to automatically adjust the rotatable angle to adapt to different display states according to the requirements of different display states. In this embodiment, a variety of display modes may be formed by different display areas of the first body 1 corresponding to different rotatable angles of the first body 1 relative to the second body 2. The user may adjust the rotation angle range of the first body 1 relative to the second body 2 according to the different display areas of the first body 1, such that the electronic device presents a variety of display modes. In different display modes, the user may limit the rotation of the first body 1 relative to the second body 2 within different rotation angle ranges. The user may adjust the rotation angle range he or she wants in a certain display mode, such that different users may obtain personalized, adjustable viewing angles that match the display mode, improving the user’s operating comfort and convenience of use, and meeting the usage needs of different people.

Optionally, when the display assembly switches to the first display state (for example, the display area is 50CM*70CM), the target assembly may automatically switch to the corresponding first target state, and adapt to the first display state with the first angle range (such as 0-130°). When the display assembly switches to the second display state (for example the display area is 50CM*80CM), the target assembly may switch to the second target state, and adapt to the second display state with the second angle range (such as 0-120°). When the display assembly switches to the third display state (for example the display area is 50CM*90CM), the target assembly may switch to the third target state, and adapt to the third display state with a third angle range (such as 0-110°), etc. Therefore, the electronic device may be able to present a variety of display modes with a better viewing angle, improve the user’s operation comfort and convenience of use, and meet the usage needs of different people.

When the first body 1 switches between the first display state and the second display state, the relationship between the structures of the first body 1 may change, resulting in different display areas for the first body. This change in the relationship between the structures of the first body 1 may change the position of the center of gravity of the first body 1. When the center of gravity of the first body 1 changes, the electronic device may not be stably placed on a desktop or other support object.

Optionally, when the first body 1 switches between the first display state and the second display state, the relationship between the structures of the first body 1 may change, causing the position of the center of gravity of the first body 1 to change. The target assembly may change the rotation angle range of the first body 1 relative to the second body 2 based on the position of the center of gravity of the first body 1. The target assembly may determine the first angular range of the first body 1 in the first display state and the second angular range of the first body 1 in the second display state based on the change in the center of gravity of the first body 1. In this embodiment, the electronic device may be able to be stably placed on a desktop or other support object. When the second body 2 of the electronic device contacts the desktop or other support object during use, the second body 2 of the electronic device may remain stationary relative to the support object.

Optionally, the size of the portion of the flexible screen located in the first body 1 may be adjusted by adjusting the size of the first body 1.

Optionally, the first body may include a movable structure, which may include a fixed part, a slidable part, and a slide member that drives the slidable part. The slidable part may slide relative to the fixed part, causing the overall size of the fixed part and the slidable part to change accordingly, thereby changing the size of the first body 1. The flexible screen may adapt to the overall size of the fixed part and the slidable part. When the overall size of the fixed part and the slidable part increases, the exposed portion of the flexible screen may adapt to the increased area of the first body 1, thereby increasing the portion of the flexible screen dedicated to display. When the overall size of the fixed part and the slidable part decreases, the exposed portion of the flexible screen may adapt to the decreased area of the first body 1, thereby reducing the portion of the flexible screen dedicated to display. By reducing the area of the first body 1 through movement of the fixed part relative to the slidable part, the area of the first body 1 may be adjusted to match that of the second body 2, making it easier to carry. By increasing the area of the first body 1 by making it larger than that of the second body 2 through movement of the fixed part relative to the slidable part, the display size of the display may be increased.

The flexible screen may be rolled up or extended using a kinematic structure to reduce or enlarge the display area, making it easier to use. When the flexible display screen is extended, the center of gravity of the screen increases. Further, the kinematic structure is typically also provided on the first body 1. This results in the first body 1 of an electronic device with a flexible display being heavier than the display of an electronic device without a flexible display. Therefore, when the center of gravity of the display increases, the electronic device may not be stably placed on a desktop or other support object.

Optionally, in some embodiments, in the first display state, the first body 1 may have a first size and a first rotation angle range relative to the second body 2. In the second display state, the first body 1 may have a second size and a second rotation angle range relative to the second body 2. When the first size is smaller than the second size, the first angular range may be larger than the second angular range. When the first size is larger than the second size, the first angular range may be smaller than the second angular range. The first body 1 may have different structures in the first display state and the second display state. Because of the changes in the relationship between the structures of the first body 1, the center of gravity of the first body 1 may also change. Optionally, when the first body 1 extends away from the rotation shaft mechanism to form the second display state, the first body 1 may rotate relative to the second body 2 by a set angle, causing the center of gravity of the first body 1 in the second display state to rise relative to the first body 1 in the first display state. The target assembly may limit the first angular range of the first body 1 in the first display state and the second angular range of the first body 1 in the second display state, allowing the electronic device to remain stable on a desktop or other support object even after its center of gravity is raised, thereby reducing the possibility of the electronic device tipping over.

Optionally, the first body 1 may include a fixed part and a slidable part, where the slidable part slides relative to the fixed part, to change the overall size of the fixed part and the slidable part, thereby varying the size of the first body 1. The flexible screen may adapt to the overall size of the fixed part and the slidable part. As the overall size of the fixed part and the slidable part increases, the exposed portion of the flexible screen may adapt to the increased area of the first body 1, thereby increasing the portion of the flexible screen available for display. As the overall size of the fixed part and the slidable part decreases, the exposed portion of the flexible screen may adapt to the decreased area of the first body 1, thereby decreasing the portion of the flexible screen available for display. The fixed part of the first body 1 may be connected to the rotation shaft mechanism. The slidable part may be able to move toward the rotation shaft mechanism to form the first display state with a smaller display area, and the slidable part may be able to move away from the rotation shaft mechanism to form the second display state with a larger display area. When the display assembly switches to the first display state, the target assembly may be switched to the first target state. When the display assembly switches to the second display state, the target assembly may be switched to the second target state. The first body 1 may have different rotation angle ranges relative to the second body 2. When the display assembly is in the first display state, the target assembly may be switched to the first target state. When the display assembly is in the second state, the target assembly may be switched to the second target state. Therefore, the second body 2 of the electronic device may be allowed to be stably placed on a desktop or other support object, reducing the possibility of the end of the first body 1 away from the rotation shaft mechanism contacting or approaching the desktop or other support object (i.e., tipping over) because of the action of gravity.

Optionally, the first body 1 may form the first display state and the second display state because of changes in the relationship between its own structures, and the position of the center of gravity of the first body 1 in the first display state and the second display state may also change accordingly. The change in the center of gravity of the first body 1 in different display states may cause the relationship between the center of gravity and the position of the support object to change. In this case, when the relative position of the center of gravity and the support object reaches a threshold angle A, the electronic device may tip over. The target assembly switching states may limit the rotation angle of the first body 1 relative to the second body 2 to a certain range, which may be configured to avoid the threshold angle A, thereby preventing tipping.

In one embodiment, the first body 1 may have the first display state and the second display state which are switchable. The target assembly may be used to limit the rotation angle range of the first body 1 relative to the second body 2. The target assembly may have the first target state and the second target state. In the first target state, the rotation angle range of the first body 1 relative to the second body 2 may be a first angle range, and in the second target state, the rotation angle range of the first body 1 relative to the second body 2 may be a second angle range. When the display assembly switches to the first display state, the target assembly may switch to the first target state. When the display assembly switches to the second display state, the target assembly may switch to the second target state. In the first display state, the display area of the display assembly may be a first area. In the second display state, the display area of the display assembly may be a second area, where the second area may be larger than the first area. The first angle range may be larger than the second angle range. When the display area of the display assembly increases, the corresponding rotation angle range of the first body 1 relative to the second body 2 may decrease, allowing the second body 2 of the electronic device to be stably placed on a desktop or other support object and reducing the possibility that the end of the first body 1 away from the rotation shaft mechanism contacts or approaches the desktop or other support object (i.e., tip over) because of the action of gravity after the angle between the first body 1 and the second body 2 is adjusted.

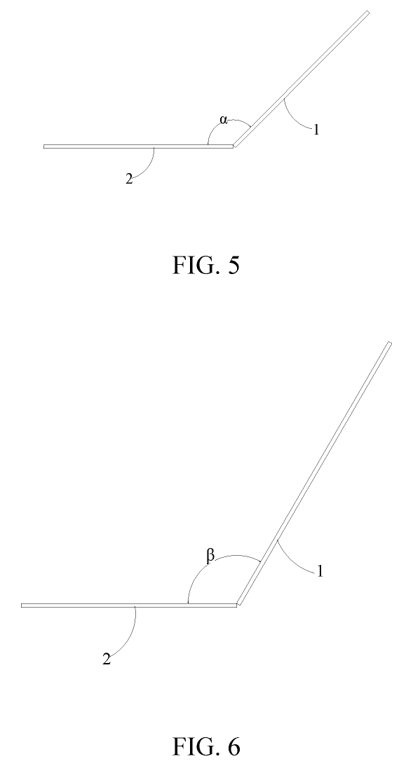

As shown in FIG. 5 illustrating the structure of the electronic device in its first display state where α represents the first angle range and FIG. 6 illustrating the structure of the electronic device in its second display state where β represents the second angle range, in one embodiment, the first angle range in the first display state may be larger than the second angle range in the second display state.

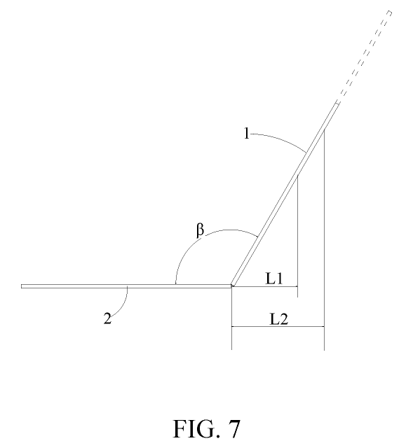

As shown in FIG. 7, where the solid line illustrates the structure of the electronic device in its first display state and the solid line extended by the dashed line illustrates the structure of the electronic device in its second display state, β represents the maximum value of the second angle range when the first body 1 is extended relative to the second body 2 in both the first display state and the second display state.

When the second area is larger than the first area, the rotation of the first body 1 relative to the second body 2 by a set angle may cause the center of gravity of the first body 1 in the second display state to rise relative to the first body 1 in the first display state. The center of gravity of the first body 1 in the first display state may be at a first height position, and the center of gravity of the first body 1 in the second display state may be at a second height position, with the second height position being higher than the first height position. When the rotation angle of the first body 1 relative to the second body is larger than 90° and the first body 1 is rotated by the same angle in the first display state and the second display state, the force arm L1 of the first body 1 in the first display state may be less than the force arm L2 of the first body 1 in the second display state, that is, the torque of the first body 1 in the first display state may be less than the torque of the first body in the second display state. The target assembly may limit the upper limit of the rotation angle of the first body 1 relative to the second body 2. When the display assembly switches to the first display state, the target assembly may switch to the first target state. In the first target state, the first body 1 may rotate relative to the second body 2 within a first angular range. When the display assembly switches to the second display state, the target assembly may switch to the second target state. In the second target state, the first body 1 may rotate relative to the second body 2 within a second angular range, which allows the first body 1 to rotate relative to the second body 2 within different angular ranges when the center of gravity of the first body 1 is located differently in different display states. By limiting the rotational angular range of the first body 1 relative to the second body 2 by the target assembly, the electronic device may be stably placed on a desktop or other support object. When the second body 2 of the electronic device contacts the desktop or other support object during use, the second body 2 of the electronic device may remain stationary relative to the support object, reducing the possibility of the end of the first body 1 away from the rotation shaft mechanism contacting or approaching the desktop or other support object because of gravity (i.e., tipping over) after the angle between the first body 1 and the second body 2 is adjusted.

In this embodiment, when the rotation angle range of the first body 1 at the maximum value of the first angle range is within the first angle range, the electronic device may use software or mechanical structures to restrict the first body 1 from switching from the first display state to the second display state, preventing the electronic device from tipping over because of the increase in the center of gravity of the first body 1 when the first body 1 is at the maximum value α of the first angle range.

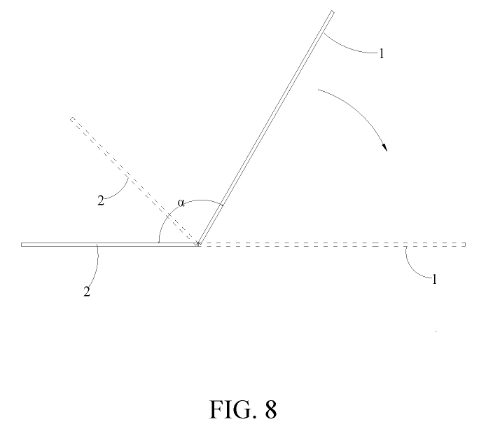

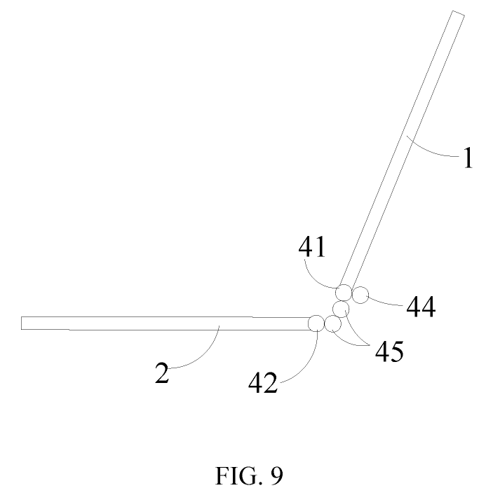

As shown in FIG. 8 where the solid line represents a schematic diagram of the electronic device in the first display state, α may represents that the opening angle of the first body 1 relative to the second body 2 may be the maximum value α of the first angle range, and the dashed line represents a schematic diagram of the structure of the electronic device after tipping over in the first display state.

In one embodiment, in conjunction with FIG. 5 to FIG. 8, α optionally represents the first angle range and β represents the second angle range. The first body 1 may switch between the first display state and the second display state. The target assembly may be used to limit the rotation angle range of the first body 1 relative to the second body 2, and the target assembly may have a first target state and a second target state. In the first target state, the rotation angle range of the first body 1 relative to the second body 2 may be a first range, and in the second target state, the rotation angle range of the first body 1 relative to the second body 2 may be a second range. In the second display state, when the first body 1 is opened to the maximum value of the first range, the second body 2 may rotate relative to a support object, which can be an object used to support the contact of the second body 2. After the second body 2 rotates relative to the support object, the end of the first body 1 away from the rotation shaft mechanism may contact the support object. In the first display state, when the first body 1 is opened to the maximum value of the first range, the second body 2 may remain stationary relative to the horizontally arranged support object, and the end of the second body 2 away from the rotation shaft mechanism may contact the support object, reducing the possibility of the end of the second body 2 away from the rotation shaft mechanism leaving the support object. By setting the maximum value of the first range, the electronic device may be stably placed on a desktop or other support object in both the first display state and the second display state.

On this basis, the first angle range may be larger than the second angle range, allowing the electronic device to be stably placed on a desktop or other support object in both the first and second display states.

Furthermore, when the first body 1 is in the second display state and is opened to the maximum angle of the first angle range, the second body 2 may rotate relative to the support object. When the first body 1 is in the second display state and is opened to the maximum angle of the second angle range, the second body 2 may remain stationary relative to the horizontally positioned support object. When the electronic device contacts the support object during use, the electronic device may remain stationary independently of the support object.

On this basis, when the first body 1 is in the first display state and opened to the maximum value of the first angular range, the second body 2 may remain stationary relative to the horizontally arranged support object. When the first body 1 is in the second display state and opened to the maximum value of the second angular range, the second body 2 may remain stationary relative to the horizontally arranged support object. When the first body 1 is in the second display state and opened to the maximum value of the first angular range, the second body 2 may rotate relative to the support. The target assembly may limit the rotatable angular range of the first body 1 relative to the second body 2, such that the rotatable angular range of the first body 1 relative to the second body 2 in the first target state is within the first angular range. In the second target state, the rotatable angular range of the first body 1 relative to the second body 2 is within the second angular range. When the electronic device contacts a support object during use, the electronic device may remain stationary independently of the support object.

In one specific embodiment, the first angle range may be 0 to 135°, and the second angle range may be 0 to 120°. In the first target state, the first body 1 may be opened to the maximum of 135° in the first angle range, achieving the user experience of a standard laptop. In the second target state, the first body 1 may be opened to the maximum of 120° in the second angle range, reducing the possibility of the end of the first body 1 away from the rotation shaft mechanism contacting or approaching a desktop or other support object (i.e., tipping over) under the influence of gravity in the second target state. This meets the user's need for a large screen while reducing the possibility of tipping over.

In one specific embodiment, the electronic device may include a first body 1, a second body 2, and a target assembly. The first body 1 may include a display assembly, which may have a switchable first display state and a second display state. The display area of the display assembly in the first display state may be different from the display area of the display assembly in the second display state. The second body 2 may be rotatably connected to the first body 1. The target assembly may be used to limit the rotation angle range of the first body 1 relative to the second body 2. The target assembly may have a first target state and a second target state. In the first target state, the rotation angle range of the first body 1 relative to the second body 2 may be the first angle range. In the second target state, the rotation angle range of the first body 1 relative to the second body 2 may be the second angle range. The second angle range may be different from the first angle range. When the display assembly switches to the first display state, the target assembly may switch to the first target state. When the display assembly switches to the second display state, the target assembly may switch to the second target state, allowing the electronic device to have different rotation angle ranges of the first body 1 relative to the second body 2 in different display states. Users may adjust the rotation angle of the first body 1 relative to the second body 2 based on the different display areas of the first body 1, allowing the electronic device to have a better viewing angle when presenting a variety of display modes, improving user comfort and convenience, and meeting the needs of different users. The target assembly switching states may limit the rotation angle of the first body 1 relative to the second body 2 to a certain range.

As shown in FIG. 1 to FIG. 4, the target assembly may include a drive member 34 and a brake member 30. The drive member 3 may include a motor, a gear, and a rotation shaft mechanism. The brake member 30 may be in a mating relationship with the rotation shaft mechanism. Optionally, when the brake member 30 and the rotation shaft mechanism are in a first mating relationship, the target assembly may be in the first target state. When the brake member 30 and the rotation shaft mechanism are in a second mating relationship, the target assembly may be in the second target state. The drive member 3 may drive the brake member 30 to switch between the first and second mating relationships with the rotation shaft mechanism.

The drive member 34 and the brake member 30 may be in a transmission connection, and the drive member 34 may be configured to drive the brake member 30, causing the brake member 30 to change its position to limit the opening angle of the first body 1 relative to the second body 2. In the first target state, the first body 1 may be able to rotate within the first angular range relative to the second body 2, and in the second target state, the first body 1 may be able to rotate within a second angular range. Changing the position of the brake member 30 may cause the rotation angle range of the first body 1 relative to the second body 2 to switch between the first angular range and the second angular range. In this embodiment, the brake member 30 may be driven by the drive member 34 to change the position of the brake member 30, thereby limiting the rotation angle range of the first body 1 relative to the second body 2. When the display assembly switches to the first display state, the target assembly may switch to the first target state, and the rotation angle range of the first body 1 relative to the second body 2 may be the first angle range. When the display assembly switches to the second display state, the target assembly may switch to the second target state, and the rotation angle range of the first body 1 relative to the second body 2 may be the second angle range. This may allow the electronic device to have different rotation angle ranges of the first body 1 relative to the second body 2 in different display states, facilitating users to adjust the angle of the first body 1 of the electronic device based on different usage needs and allowing users to find the appropriate usage angle of the first body 1 of the electronic device in different display states, thereby improving the user experience of the electronic device. The electronic device may also be stably placed on a desktop or other support object. That is, when the electronic device contacts the support object during use, the electronic device may remain in a static state independent of the support object.

In one embodiment, the electronic device may include a first body 1, a second body 2 and a target assembly. The first body 1 may include a display assembly, and the first body 1 may have a switchable first display state and a second display state. The target assembly may have a first target state and a second target state.

The target assembly may include a drive member 34, a brake member 30 and a rotation shaft mechanism. The drive member 34 and the brake member 30 may be connected in transmission. The drive member 34 may be used to drive the brake member 30. The rotation shaft mechanism may include a first rotation member 31, a second rotation member 32 and a connection assembly 33. The first rotation member 31 and the second rotation member 32 may be rotationally connected through the connection assembly 33. The first rotation member 31 may be connected to the first body 1, and the second rotation member 32 may be connected to the second body 2. Optionally, the first rotation member 31 and the first body 1 may be connected by fasteners or by welding, and the second rotation member 32 and the second body 2 may be connected by fasteners or by welding. Optionally, the first rotation member 31 may include a first rotation shaft and a first connecting member arranged on the first rotation shaft. The first connecting member may be rotatably connected to the first rotation shaft, and the first connecting member may be used to connect to the first body 1. The second rotation member 31 may include a second rotation shaft and a second connecting member arranged on the second rotation shaft. The second connecting member may be rotatably connected to the second rotation shaft, and the second connecting member may be used to connect to the second body 2. The connection assembly may be a gear assembly or a hinge. The connection assembly may be arranged on the first rotation shaft and the second rotation shaft, and may be connected to the first connecting member and the second connecting member, respectively. The brake member 30 may be coaxially arranged with the first rotation member 31, and the axial direction of the brake member 30 may be on the same straight line as the axial direction of the first rotation member 31. Optionally, the moving direction of the brake member 31 may be the same as the axial direction of the first rotation member 31. The first rotation member 31 may have an abutment member 311. The drive member 34 may be used to drive the brake member 30 to move axially along the first rotation member 31, allowing the brake member 30 to move closer to or further from the first rotation member 31 along the axis of the first rotation member 31. This may allow the brake member 30 to abut the abutment member 311 in the first position to limit the rotation angle of the first rotation member 31, or to disengage from the abutment member 311 in the second position. When the brake member 30 is in the first position, it may abut the abutment member 311, allowing the target assembly to switch to the second target state. When the brake member 30 is in the second position, it may disengage from the abutment member 311, allowing the target assembly to switch to the first target state. When the brake member 30 is disengaged from the abutment member 311, the target assembly may remain out of contact with the abutment member 311 during rotation of the first body 1 relative to the second body 2. In this embodiment, the drive member 34 may drive the brake member 30, allowing the position of the brake member 30 to change, thereby switching the target state of the target assembly. When the display assembly is switched to the first display state, the brake member 30 may be in the second position, the target assembly may be switched to the first target state, and the first body 1 may rotate relative to the second body 2 within the first angle range. When the display assembly is switched to the second display state, the brake member 30 may be in the first position, the target assembly may be switched to the second target state, and the first body 1 may rotate relative to the second body 2 within the second angle range. This may allow the electronic device to rotate relative to the second body 2 within different angle ranges in different display states, allowing it to be stably placed on a desktop or other support object. That is, when the electronic device contacts a support object during use, the electronic device may maintain an independent static state relative to the support object.

Optionally, the first rotation member 31 may include a first rotation shaft and a first connecting plate. The first connecting plate may be fixed to the first rotation shaft and the first connecting plate may be fixed to a fixing portion. A clamping plate may be fixed to the first rotation shaft, and the clamping plate may include a clamping portion.

The second rotation member 32 may include a second rotation shaft and a second connecting plate. The second connecting plate may be fixed to the second rotation shaft, and the second connecting plate may be fixed to the second body 2. Optionally, multiple gears may mesh to enable the second rotation shaft to rotate in a planetary manner about the first rotation shaft.

Optionally, the first rotation member 31 and the second rotation member 32 may each be rotatably connected to a connection assembly 33. Optionally, the connection assembly 33 may include multiple intermeshing gears.

In one embodiment, the electronic device may include a first body 1, a second body 2, and a target assembly. The first body 1 may include a display assembly, and the first body 1 may have a switchable first display state and a second display state. The target assembly may have a first target state and a second target state. The target assembly may include a drive member 34, a brake member 30, and a rotation shaft mechanism. The drive member 34 and the brake member 30 may be connected in transmission. The drive member 34 may be used to drive the brake member 30. The rotation shaft mechanism may include a first rotation member 31, a second rotation member 32, and a connection assembly 33. The first rotation member 31 and the second rotation member 32 may be rotationally connected via the connection assembly 33. The first rotation member 31 may be connected to the first body 1, and the second rotation member 32 may be connected to the second body 2. The first rotation member 31 may be provided with an abutment member 311. The electronic device may further include a controller for generating a first control signal or a second control signal. The controller may be connected to the drive member 34, and the drive member 34 may be used to drive the brake member 30 to move to the first position according to the first control signal, such that the brake member 30 abuts the abutment member 311 to limit the rotation angle of the first rotation member 3 and the maximum expansion angle of the first body 1 relative to the second body 2 is the second angle. The drive member 34 may also be used to drive the brake member 30 to move to the second position according to the second control signal, such that the brake member 30 is disengaged from the abutment member 311 and the maximum expansion angle of the first body 1 relative to the second body 2 is the first angle. Optionally, the first angle may be the maximum value of the first angle range, and the second angle may be the maximum value of the second angle range. The brake member 30 may be coaxially arranged with the first rotation member 31, and the first rotation member 31 may be provided with the abutment member 311. When the controller generates the first control signal, the drive member 34 may drive the brake member 30 to move toward the first position, allowing the brake member 30 to abut the abutment member 311, and the target assembly switches to the second target state, enabling the first body 1 to have a maximum opening angle relative to the second body 2 of the second angle. When the controller generates the first control signal, the drive member 34 may drive the support member to move toward the second position, allowing the brake member 30 to separate from the abutment member 311, and the target assembly switches to the first target state, enabling the first body 1 to have a maximum opening angle relative to the second body 2 of the first angle. In this embodiment, the controller may control the drive member 34 to drive the brake member 30, thereby changing the position of the brake member 30 and switching the target state of the target assembly. When the display assembly switches to the first display state, the brake member 30 may be in the second position, the target assembly may switch to the first target state, and the first body 1 may rotate relative to the second body 2 within the first angular range. When the display assembly switches to the second display state, the brake member 30 may be in the first position, the target assembly may switch to the second target state, and the first body 1 may rotate relative to the second body 2 within the second angular range. Therefore, when the electronic device is in different display states, the rotation angle range of the first body 1 relative to the second body 2 may be different, such that it may be stably placed on a desktop or other support object. That is, when the electronic device contacts the support object during use, the electronic device may maintain an independent static state with the support object.

Optionally, when a key is operated on the electronic device, a control signal corresponding to the key operation may be generated. The control signal may be a first control signal, a second control signal, or a third control signal. The drive member 34 may perform a corresponding control operation based on the control signal. Based on the first control signal, the drive member 34 may drive the brake member 30 to move toward the first position such that the brake member 30 may abut the abutment member 311, thereby limiting the rotation angle of the first rotation member 31 and enabling the first body 1 to have a maximum opening angle relative to the second body 2 of the second angle.

Based on the above, the abutment member 311 may include an abutment wall 311a. When the controller generates the first control signal, the drive member 34 may drive the brake member 30 to move toward the first position such that the brake member 30 may abut the abutment wall 311a, and the target assembly may switch to the second target state such that the first body 1 may have a maximum opening angle relative to the second body 2 of the second angle. The abutment wall 311a may abut the brake member 30 when the first body 1 is deployed at the second angle relative to the second body 2. This may allow the first body 1 to rotate at the maximum angle relative to the second body 2 when the electronic device is in the second display state. This may allow the second body 2 to remain stationary relative to a horizontally disposed support object when the electronic device is deployed at the second angle. When the second body 2 of the electronic device contacts a support object during use, the possibility of the end of the first body 1, distal from the rotation shaft mechanism, contacting or approaching a desktop or other support object (i.e., tipping over) because of the gravity may be reduced, allowing the electronic device to remain stably placed on a desktop or other support object.

In one embodiment, the electronic device may include a first body 1, a second body 2, and a target assembly. The first body 1 may include a display assembly, and the first body 1 may have a switchable first display state and a second display state. The target assembly may have a first target state and a second target state. The target assembly may include a drive member 34, a brake member 30, a rotation shaft mechanism, a first support member 35, and/or a second support member 39. The drive member 34 and the brake member 30 may be connected in transmission, and may be used to drive the brake member 30. The rotation shaft mechanism may include a first rotation member 31, a second rotation member 32, and a connection assembly 33. The first rotation member 31 and the second rotation member 32 may be rotationally connected via the connection assembly 33. The first rotation member 31 may be connected to the first body 1, and the second rotation member 32 may be connected to the second body 2. The first rotation member 31 may be provided with an abutment member 311. The brake member 30 may be coaxially arranged with the first rotation member 31, and the drive member 34 may be used to drive the brake member 30 to move axially along the first rotation member 31, such that the brake member 30 abuts the abutment member 311 in the first position to limit the rotation angle of the first rotation member 31 and the brake member 30 is separated from the abutment member 311 in the second position. The first support member 35 may be connected to the second body 2. Optionally, the first support member 35 and the second body 2 may be connected by fasteners. The drive member 34 may be installed at the first support member 35, and the output end of the drive member 34 may be connected to the screw rod 38 to drive the screw rod 38 to rotate. The first support member 35 may be provided with a guide post 36, and the guide post 36 may be slidably matched with a slider 37. The slider 37 may be threadedly matched with the screw rod 38, and the slider 37 may be connected to the brake member 30. When the drive member 34 rotates the screw rod 38, the slider 37 disposed at the screw rod 38 may move axially along the screw rod 38. When the slider 37 moves toward the first rotation member 31, the slider 37 may drive the brake member 30, causing the brake member 30 to move to the first position, thereby causing the brake member 30 to abut the abutment member 311. The target assembly may switch to the second target state, such that the maximum opening angle of the first body 1 relative to the second body 2 may be the maximum value of the second angular range. Optionally, the slider 37 and the brake member 30 may be connected by a connection rod 40. When the brake member 30 is separated from the abutment member 311, the target assembly may switch to the first target state, such that the maximum opening angle of the first body 1 relative to the second body 2 may be the maximum value of the first angular range. The slider 37 may slide with the guide post 36, allowing the slider 37 to move axially along the guide post 36, improving the stability of the movement of the slider 37, thereby improving the stability of the brake member 30 and the stability of the target assembly switching between the first and second target states.

Optionally, the second support member 39 may be connected to the second body 2 and provided with a guide hole. The brake member 30 may slidably engage with the guide hole, allowing the brake member 30 to slide along the guide hole, thereby improving the stability of the brake member 30 and the stability of the target assembly when switching between the first and second target states.

Based on the above, the brake member 30 may have a limiter located at one end of the brake member 30 proximal to the first rotation member 31. The limiter may abut the abutment member 311 in the first position and disengage from the abutment member 311 in the second position. When the drive member 34 actuates the brake member 30 to move to the first position, the limiter may abut the abutment member 311, and the target assembly may switch to the second target state, enabling the maximum opening angle of the first body 1 relative to the second body 2 to be the maximum value of the second angular range. When the drive member 34 drives the brake member 30 to move to the second position, the limiter may separate from the abutment member 311, and the target assembly switches to the first target state, enabling the maximum opening angle of the first body 1 relative to the second body 2 to be the maximum value of the first angle range.

In one embodiment, as shown in FIG. 9, the electronic device may include a first body 1, a second body 2, and a target assembly. The first body 1 may include a display assembly that is able to switch between a first display state and a second display state. The target assembly may have a first target state and a second target state. The target assembly may include a drive member 34, a first rotation shaft, a second rotation shaft, and a controller. The first rotation shaft may be provided with a first gear 41 that is able to be connected to the first body 1. The second rotation shaft may be provided with a second gear 42 that is able to be connected to the second body 2. The first gear 41 and the second gear 42 may be in transmission connection, enabling the first body 1 to rotate relative to the second body 2. Optionally, the first gear 41 and the second gear 42 may be connected by a plurality of intermeshing gears, enabling the first body 1 and the second body 2 to rotate synchronously in opposite directions.

The output end of the drive member 34 may be in driving connection with one of the first gear 41 and the second gear 42. Alternatively, the drive member 34 may be a drive motor with a drive gear 44 mounted on its output end. The drive gear 44 may mesh with one of the first gear 41 and the second gear 42.

The controller may be configured to generate a third control signal or a fourth control signal. The drive member 34 may be connected to the controller and configured to drive the first gear 41 or the second gear 42 based on the third control signal or the fourth control signal.

For example, in one embodiment, the drive member 34 may drive the first gear 41. When the controller generates the third control signal, the drive member 34 may drive the drive gear 44 to rotate the first gear 41, which rotates by a first rotation angle. When the first gear 41 rotates by the first rotation angle, the first body 1 may rotate relative to the second body 2. When the controller generates the fourth control signal, the drive member 34 may drive the drive gear 44 to rotate the first gear 41, which rotates by a second rotation angle, and the first body 1 rotates relative to the second body 2. In this embodiment, the drive member 34 may drive the first gear 41 or the second gear 42 to rotate by different angles, thereby enabling the first body 1 to have different rotatable angles relative to the second body 2 in different display states of the electronic device. This may not only facilitate user adjustment of the angle of the first body 1 of the electronic device based on different usage needs, allowing the user to find the appropriate angle for the first body 1 of the electronic device in different display states, thereby improving the user experience of the electronic device, but also may allow the electronic device to be stably placed on a desktop or other support object. That is, when the electronic device contacts the support object during use, the electronic device may remain stationary independent of the support object.

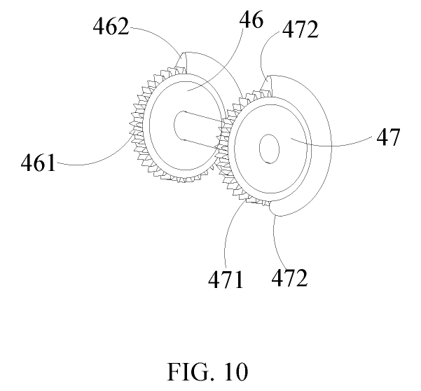

In one embodiment, as shown in FIG. 10, the electronic device may include a first body 1, a second body 2, and a target assembly. The first body 1 may include a display assembly, which may have a switchable first display state and a second display state. The target assembly may have a first target state and a second target state. The target assembly may include a first rotation shaft, a second rotation shaft, and a drive member 34. The first rotation shaft may be provided with a fourth gear 46 and a fifth gear 47, each of which is fixedly connected to the first rotation shaft and the first body 1, respectively.

The second rotation shaft may be provided with a third gear, which is slidably engaged with the second rotation shaft. The third gear may be connected to the second body 2, and may be movable relative to the second body 2 along the axis of the second rotation shaft. Alternatively, the second rotation shaft may be fixed to the second body 2, and the third gear may be movable along the axis of the second rotation shaft on the second rotation shaft. When the third gear rotates, the third gear may drive the second body 2 to rotate. Alternatively, the second rotation shaft may be fixed to the second body 2, and the third gear may be movable along the axis of the second rotation shaft. The third gear may be able to rotate with respect to the second rotation shaft.

The fourth gear 46 may be provided with a first toothed structure 461 and a first stop 462 on its circumferential side. The first stop 462 may be disposed at two ends of the first toothed structure 461. The fifth gear 47 may be provided with a second toothed structure 471 and a second stop 472. The second stop 472 may be disposed at two ends of the second toothed structure. The drive member 34 may be drivingly connected to the third gear, driving the third gear to engage with the first toothed structure 461 or the second toothed structure 471, thereby rotating the first body 1 relative to the second body 2. Optionally, the drive member 34 may include a movable member that drives the third gear to move axially along the second rotation shaft. The movable member may be a cylinder or other structure. The drive member 34 may include a drive motor that drives the third gear to rotate. Optionally, after the third gear engages with the first toothed structure 461, the drive member 34 may drive the third gear to rotate the fourth gear 46. Alternatively, after the third gear engages with the second toothed structure 471, the drive member 34 may drive the third gear to rotate the fifth gear 47.

The number of teeth in the first toothed structure 461 may be different from the number of teeth in the second toothed structure 471. This may allow the first body 1 to rotate relative to the second body 2 within the first angular range when the third gear engages the first toothed structure 461, and allow the first body 1 to rotate relative to the second body 2 within the second angular range when the third gear engages the second toothed structure 471. When the third gear engages the first toothed structure 461, the display assembly may switch to the first display state, and when the third gear engages the second toothed structure 471, the display assembly may switch to the second display state. This may not only facilitate user adjustment of the angle of the first body 1 of the electronic device based on different usage needs, allowing the user to find the appropriate angle for the first body 1 of the electronic device in different display states, thereby improving the user experience of the electronic device, but also may allow the electronic device to be stably placed on a desktop or other support object. That is, when the electronic device contacts the support object during use, the electronic device may remain stationary independent of the support object.

It should be understood that the various forms of the processes shown above can be used to reorder, add, or delete steps. For example, the steps described in the present disclosure can be performed in parallel, sequentially, or in a different order, as long as the desired results of the technical solutions disclosed in the present disclosure can be achieved, which is not limited herein.

The above describes in detail a plurality of embodiments of the present disclosure, but the present disclosure is not limited to these specific embodiments. Those skilled in the art can make various variations and modifications based on the concept of the present disclosure, and these variations and modifications shall fall within the scope of the present disclosure.

What is claimed is:

1. An electronic device comprising:
a first body including a display assembly, the first body being configured to switch between a first display state and a second display state, and a display area of the display assembly in the first display state being different from the display area of the display assembly in the second display state;
a second body rotatably connected to the first body; and
a target assembly configured to limit a rotation angle range of the first body relative to the second body, and configured to:
in response to the display assembly switching to the first display state, switch to a first target state, in which the rotation angle range of the first body relative to the second body is a first angular range, and
in response to the display assembly switching to the second display state, switch to a second target state, in which the rotation angle range of the first body relative to the second body is a second angular range different from the first angular range.

2. The device according to claim 1, wherein:
the display area of the display assembly in the first display state is larger than the display area of the display assembly in the second display state; and
the first angle range is larger than the second angle range.

3. The device according to claim 1, wherein the first angle range is selected such that:
if the first body is in the second display state and is opened to a maximum value of the first angle range, the second body rotates relative to a support object that supports the second body; and
if the first body is in the first display state and is opened to the maximum value of the first angle range, the second body remains stationary relative to the support object.

4. The device according to claim 3, wherein:
the target assembly includes a drive member and a brake member connected in transmission; and
the drive member is configured to drive the brake member to change a position of the brake member, to limit an opening angle of the first body relative to the second body, such that the rotation angle range of the first body relative to the second body in the first target state is the first angle range and the rotation angle range of the first body relative to the second body in the second target state is the second angle range.

5. The device according to claim 4, wherein:
the target assembly further includes a rotation shaft mechanism, including a first rotation member, a second rotation member, and a connection assembly;
the first rotation member and the second rotation member are rotatably connected through the connection assembly;
the first rotation member is connected to the first body, and the second rotation member is connected to the second body;
the brake member is coaxially arranged with the first rotation member;
the first rotation member is provided with an abutment member; and
the drive member is configured to drive the brake member to move along an axial direction of the first rotation member, such that the brake member abuts the abutment member when in a first position to limit the rotation angle of the first rotation member and the brake member is separated from the abutment member when in a second position.

6. The device according to claim 5, further comprising:
a controller connected to the drive member and configured to generate a first control signal or a second control signal;
wherein the drive member is configured to:
drive the brake member to move toward the first position in response to the first control signal, to cause the brake member to abut the abutment member, thereby limiting a rotation angle of the first rotation member and ensuring that a maximum opening angle of the first body relative to the second body is a second angle; and
drive the brake member to move toward the second position in response to the second control signal, thereby separating the brake member from the abutment member and ensuring that the maximum opening angle of the first body relative to the second body is a first angle.

7. The device according to claim 5, wherein:
the target assembly further includes a support member connected to the second body and including a guide post;
the drive member is installed at the support member, an output end of the drive member is connected to a screw rod and configured to drive the screw rod to rotate; and
the guide post is slidably fitted with a slider threadedly fitted with the screw rod and connected to the brake member.

8. The device according to claim 5, wherein:
the target assembly further includes a support member provided with a guide hole; and
the brake member is slidably fitted with the guide hole.

9. The device according to claim 5, wherein:
the brake member includes a limiter arranged at one end of the brake member close to the first rotation member; and
the limiter is configured to abut the abutment member when in the first position, and be separated from the abutment member when in the second position.

10. The device according to claim 1, wherein:
the target assembly includes a drive member, a first rotation shaft, and a second rotation shaft;
the first rotation shaft includes a first gear connected to the first body;
the second rotation shaft includes a second gear connected to the second body;
the first gear and the second gear are in driving connection with each other such that the first body is able to rotate relative to the second body; and
an output end of the drive member is in driving connection with one of the first gear or the second gear.

11. The device according to claim 10, wherein:
the target assembly further includes a controller connected to the drive member; and
the controller is configured to generate:
a first control signal that controls the drive member to drive the first gear, or
a second control signal that controls the drive member to drive the second gear.

12. The device according to claim 1, wherein:
the target assembly includes a first rotation shaft, a second rotation shaft, and a drive member;
the first rotation shaft includes a first gear and a second gear, each of which is fixedly connected to the first rotation shaft and the first body; and
the second rotation shaft includes a third gear slidably engaged with the second rotation shaft and connected to the second body, and movable relative to the second body along an axial direction of the second rotation shaft.

13. The device according to claim 12, wherein:
the first gear includes a first toothed structure and a first stopper on a circumferential side of the first gear, and the first stopper is disposed at two ends of the first toothed structure;
the second gear includes a second toothed structure and a second stopper disposed at two ends of the second toothed structure; and
the drive member is drivingly connected to the third gear and configured to drive the third gear to mesh with the first toothed structure or the second toothed structure, thereby enabling the first body to rotate relative to the second body.

14. The device according to claim 13, wherein:
the first toothed structure has a different number of teeth from the second toothed structure, such that the first body is able to rotate relative to the second body within the first angular range when the third gear meshes with the first toothed structure and to rotate relative to the second body within the second angular range when the third gear meshes with the second toothed structure.
